(19) United States
(12) Patent Application Publication
(10) Pub. No.: US 2014/0108918 A1
(43) Pub. Date: Apr. 17, 2014

(54) Method for Processing an Effect of Extracting and Moving a Section on an Output Display of a Webpage

(71) Applicants: Seung June Song, Seoul (KR); Seung Ik Lee, Seoul (KR)

(72) Inventors: Seung June Song, Seoul (KR); Seung Ik Lee, Seoul (KR)

(73) Assignee: SECHANG INSTRUMENTS CO., LTD., Seoul (KR)

(21) Appl. No.: 14/116,867

(22) PCT Filed: May 9, 2012
(86) PCT No.: PCT/KR2012/003623

§ 371 Date: Nov. 11, 2013

(30) Foreign Application Priority Data
May 11, 2011 (KR) 10-2011-0043809

(51) Int. Cl. G06F 17/22

(52) U.S. Cl. CPC G06F 17/2247
USPC 715/234

(57) ABSTRACT

Position values of sections (81, 82 and 83) on output display of a webpage according to the same kind of files are extracted from the output-display (800) of the webpage. A transparent layer (8000) corresponding to the size of the output display of the webpage is generated. An entire output display capture layer (8000′) is generated by capturing the output display of the webpage and uploading it on the transparent layer and with reference to the extracted position values of the sections of the output display, output-display section layers (81′, 82′ and 83′) corresponding to the sizes of the sections of the output-display are generated, and portions (811, 812, and 813) corresponding to the sections of the output-display from the entire output-display capture layer (800) are captured and uploaded on the output-display section layers (81′, 82′ and 83′) so that output-display section capture layers (81″, 82″ and 83″) are generated. Then, movement effect is executed by using the output-display section capture layers (81″, 82″ and 83″) as objects.

### BACKGROUND OF THE INVENTION

The present invention relates to a method of processing an effect of extracting and moving a section on an output display of a webpage, and more particularly to a method of processing an effect of extracting and moving a section on an output display of a webpage which creates an effect that the section of a particular kind of file on an output display of a webpage are extracted and moved. According to the present invention, for example, a scene may be produced where video sections such as Flash video are extracted on an output display of a webpage and the extracted video sections are moved.

It may be required to produce a scene where particular sections are extracted on an output display of a web page and the extracted sections are moved. For example, in Korean patent application no. 10-2010-0047109 or 10-2010-0062823 by the applicant, a user may designate particular sections from a utilization website which the user desires to use and assemble the designated particular sections into a target website. In connection with the designation of the particular sections, it is desirable if a scene where the particular section is extracted on an output display of a webpage and the extracted particular section is moved is produced. The scene enables the user to identify which section has been designated and assembled.

The present invention makes it possible to produce the scene in which the particular section is extracted on the output display of the webpage and the extracted section is moved.

The present invention is to provide a processing method producing a scene in which section of a particular kind of file is extracted on an output display of a webpage and the extracted section is moved. By the present invention, a user can produce a scene where the same kind of service units (video, image, or web slice) within the same page is extracted without specialized knowledge.

### SUMMARY OF THE INVENTION

The present invention provides a method of processing an effect of extracting and moving a section on an output display of a webpage, the method comprising the steps of: Extraction of section-position value step wherein position value of the section of a particular file on the output display of the webpage is extracted; Transparent layer generation step wherein a transparent layer having a size fitting the size of the output display of the webpage is generated; Entire output display capture layer generation step wherein the output display of the webpage is captured and the captured output display of the webpage is put on the transparent layer so that an entire output display capture layer having the captured output display of the webpage thereon is generated; Section capture layer generation step wherein a section layer having a size fitting the size of the section is generated according to the position value of the section extracted in the extraction of section-position value step and a section capture layer is generated by capturing a section at position corresponding to the position value of the section extracted in the extraction of section-position value step from the entire output display capture layer and putting the captured section on the section layer; and Moving effect production step producing an effect that the section capture layer is moved.

According to the present invention, a scene where a section of a particular kind of file is extracted and moved can be produced. Particularly, the present invention provides an advantage to identify all the files of the same kind because all the sections of the same kind of the file, even located at an unobserved place such as a bottom part of the webpage, are extracted and moved.

### BRIEF DESCRIPTION OF THE DRAWINGS

FIG. 1 is a schematic illustration of a website section assembling system to which an embodiment of the present invention is applied;

FIG. 2 is a flowchart of a processing sequence of a method of processing an effect of extracting and moving a section on an output display of a webpage according to the present invention;

FIG. 3 is a schematic illustration of a webpage showing logic calculating position values of a section when a space of an output display of the webpage is divided;

FIG. 4 is a schematic illustration of a generation of a transparent layer corresponding to an output display of a webpage;

FIG. 5 is a schematic illustration of an entire output display capture layer generated by capturing an output display of a webpage and putting the captured output display of the web page on a transparent layer corresponding to the output display of the webpage;

FIG. 6 is a schematic illustration of section layers having sizes fitting the sections with reference to position values of the sections and section capture layers generated by capturing the sections from the entire output display capture layer and putting the capture output display sections on the output display section layers; and

FIG. 7 is a schematic illustration of (in subviews (a), (b), and (c)) an example of an operation according to the present invention.

### DETAILED DESCRIPTION

Exemplary embodiments of the present invention will be described with reference to the accompanying drawings.

The present embodiment discloses a case applied to the embodiments in Korean application no. 10-2010-0047109 or 10-2010-0062823, but the case is merely an example and the present invention is not dependent on the above applications. The two applications are incorporated into this specification.

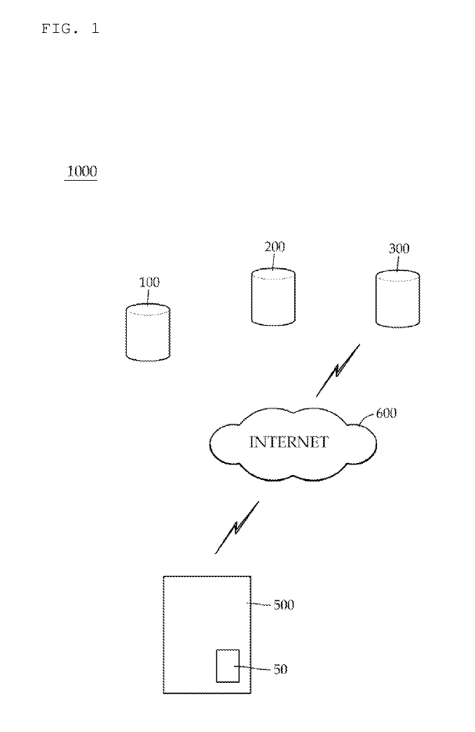

First, FIG. 1 shows a website section assembling system 1000 according to the above applications to which the present embodiment is applied.

A website section assembling server 100 is provided, a website section assembling service apparatus 50 is installed to a user computer 500 having a web browser, and a utilization website 200 including a webpage of which sections are desired to be used by a user and a target website 300 which the sections of the utilization website are assembled into and output to are provided. The user computer 50 and the website section assembling server 100, and the utilization website 200 and the target website 300 are connected to each other through an internet 600.

In the present embodiment, the website section assembling service apparatus 50 directs a scene in which a section of a particular kind of file on the output display of the webpage are extracted and moved. Meanwhile, the extracted section is assembled into an output display of the target website 300 by the selection of a user.

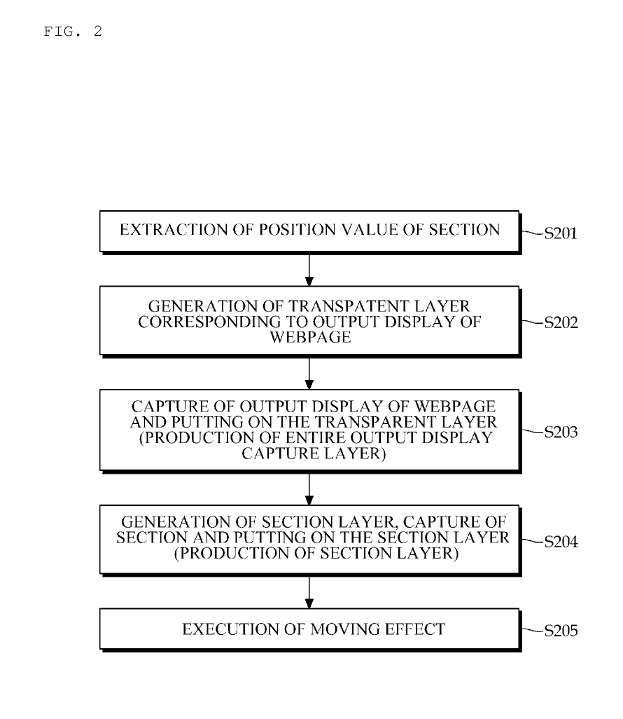

FIG. 2 illustrates a processing sequence for creating an effect of extracting the section of a particular kind of file on the output display of the webpage and moving the extracted section according to the present embodiment.

First, when the user computer 500 accesses the utilization website 200 and a webpage of the utilization website 200 starts being loaded to the user computer 500, the website section assembling service apparatus 50 analyzes the DOM structure thereof and extracts position value of the section to be extracted according to the particular kind of file and the URL of the webpage of the utilization website having the section (step S201).

For example, when Flash video file is to be extracted, position value of the section (hereinafter referred to as a “Flash section”) displaying the flash video file and the URL of the webpage thereof are extracted. In this event, the position value of the section is to be position value of the utilization section.

When the section is a quadrangle, the position value of the section may be X and Y coordinate values, a width W, and a height H based on a top left of the output display of the webpage.

When the section is included in a divided space within the webpage, X and Y coordinate values based on the top left of the output display of the webpage may be acquired by calculating a distance from the top left of the output display of the webpage to the divided space and a distance from the divided space to a position where the section is located.

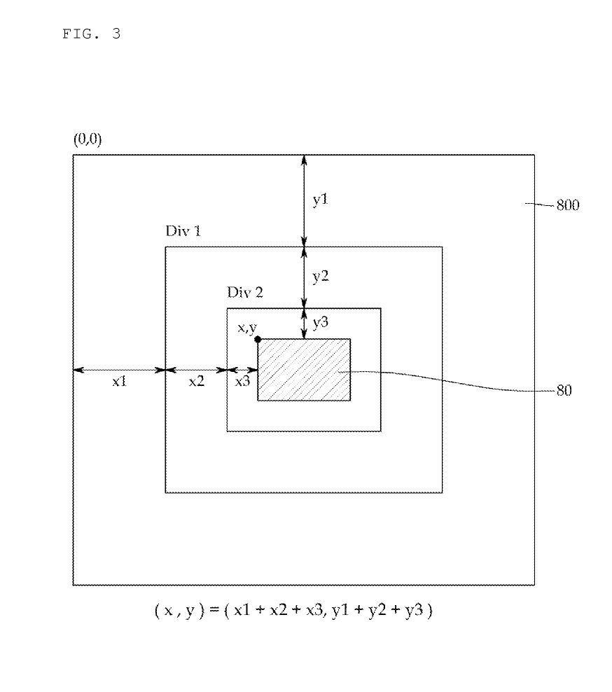

For example, as illustrated in FIG. 3, when a space of an output display of a webpage 800 is divided by a tag div1 and a tag div2 and there is a Flash section 80 within the space generated by the tag div2, x and y coordinate values of the Flash section 80 in the output display of the webpage can be acquired by calculating each of a distance (x1, y1) from a top left (0, 0) of the output display of the webpage to the space by the tag div1, a distance (x2, y2) from the space by the tag div1 to the space by the tag div2, and a distance (x3, y3) from the space by the tag div2 to the Flash section 80 and then adding all the distances.

Next, when the webpage of the utilization website is loaded on the user computer 500 and an extraction command for extracting section according to a particular kind of file is received from the user through an input device, the website section assembling service apparatus 50 generates a transparent layer having a size corresponding to the size of the webpage on the output display of the webpage (step S202).

That is, the layer is generated on the output display of the webpage such that the size of the layer fits the webpage, and an attribute thereof is set as being transparent. For example, the transparent layer described herein may be a canvas layer based on the HTML 5 standard.

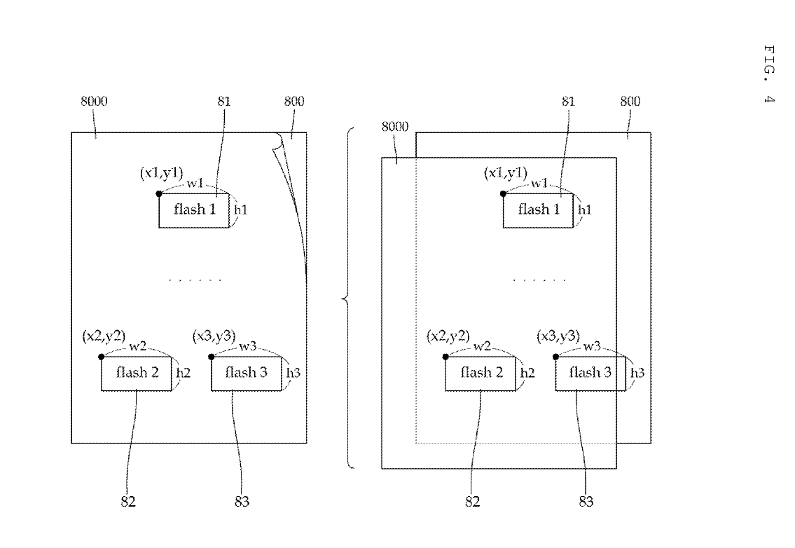

Referring to FIG. 4, with respect to the output display of the webpage 800 including three Flash sections 81, 82, and 83, a transparent layer 8000 is formed. In this event, (x1, y1, w1, h1), (x2, y2, w2, h2), and (x3, y3, w3, h3) are extracted as position values of the three Flash sections 81, 82, and 83, respectively.

Next, the website section assembling service apparatus 50 captures the output display of the webpage 800 and puts the captured output display of the webpage on the transparent layer 8000, so as to generate an entire output display capture layer 8000′ (step S203).

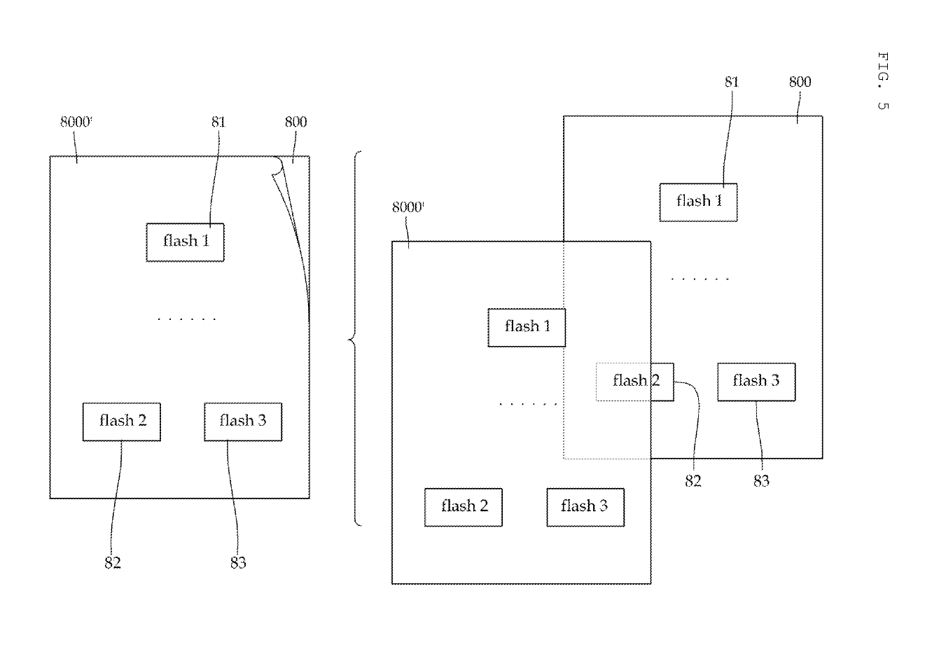

Referring to FIG. 5, the entire output display capture layer 8000′ which is generated by putting the captured output display of the webpage 800 on the transparent layer 8000 is illustrated.

Next, the website section assembling service apparatus 50 generates section layers 81′, 82′, and 83′ having sizes fitting the sections 81, 82, and 83 with reference to the position values of the 81, 82, and 83 extracted in step S201, and also generates section capture layers 81″, 82″, and 83″ by capturing sections 811, 812, and 813 from the entire output display capture layer 8000′ and putting the captured sections 811, 812, and 813 on the output display sections 81′, 82′, and 83′. For example, the section layer described herein may be a canvas layer based on the HTML5 standard (step S204).

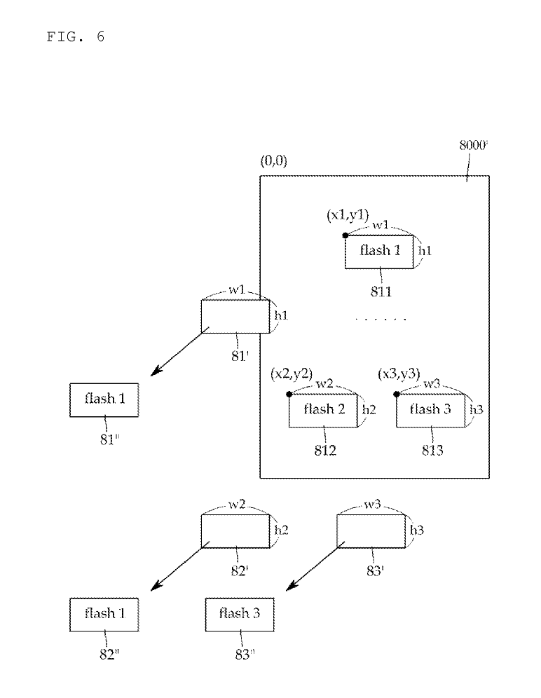

Referring to FIG. 6, in connection with the Flash section 81, the layer 81′ having a width w1 and a height h1 is generated with reference to position value of the Flash section 81 (x1, y1, w1, h1) and the section capture layer 81″is generated by capturing the section 811 corresponding to the Flash section 81 from the entire output display capture layer 8000′ with reference to the position values (x1, y1, w1, h1) and putting the captured section 811 on the layer 81′.

In connection with the Flash section 82, the layer 82′ having a width w2 and a height h2 is generated with reference to position value of the Flash section 82 (x2, y2, w2, h2) and the section capture layer 82″is generated by capturing the section 812 corresponding to the Flash section 82 from the entire output display capture layer 8000′ with reference to the position values (x2, y2, w2, h2) and putting the captured section 812 on the layer 82′.

In connection with the Flash section 83, the layer 83′ having a width w3 and a height h3 is generated with reference to position value of the Flash section 83 (x3, y3, w3, h3) and the section capture layer 83″ is generated by capturing the section 813 corresponding to the Flash section 83 from the entire output display capture layer 8000′ with reference to the position values (x3, y3, w3, h3) and putting the captured section 813 on the layer 83′.

Next, an effect of moving the section capture layers 81″, 82″, and 83″is executed. According to the present embodiment, images are generated with the generated section capture layers 81″, 82″, and 83″ as objects by means of Jquery library and the moving effect is produced by means of the animation API.

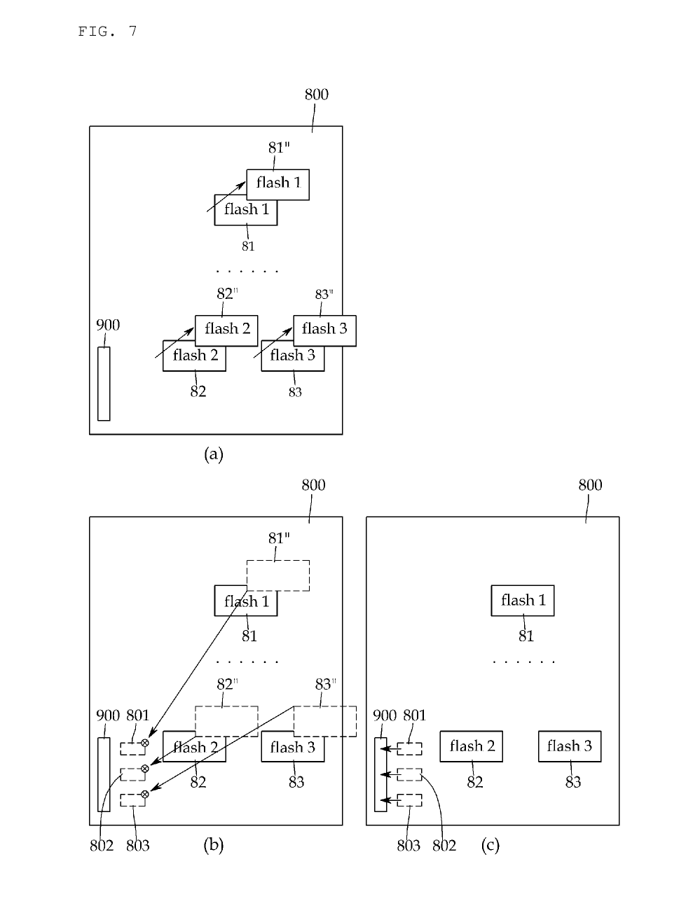

In this event, as illustrated in FIG. 7, a scene may be directed where the section capture layers 81″, 82″, and 83″ are displayed at upper right sides (FIG. 7(a)), the section capture layers 81″, 82″, and 83″are moved to a side bar 900 and displayed in a form of thumbnails 801, 802, and 803 (FIG. 7(b)), and then some of the thumbnails 801, 802, and 803 selected by the user enter the side bar 900 (FIG. 7(c)).

Thereafter, some values selected from the position values (x1, y1, w1, h1), (x2, y2, w2, h2), and (x3, y3, w3, h3) of the utilization sections 81, 82, and 83, and the URL of the webpage of the utilization webpage are transmitted to and stored in the website section assembling server 100, and then assembled into the target website 300 according to a selection by the user. A detailed description thereof will be omitted since it is included in the aforementioned filed applications.

As described above, according to the present invention, the scene is directed in which the section of a particular file, such as a flash video, is extracted on the output display of the webpage and the extracted section is moved. Particularly, the present invention provides an advantage to identify all the files of the same kind because all the sections of the same kind of the file, even located at an unobserved place such as a bottom part of the webpage, are extracted and moved.

When the utilization sections of the utilization website are assembled into the target website, the present invention is advantageous because, according to the present invention, sections to be utilized can be visually easily recognized and defined by merely one or two clicks. The present invention can be applied for sharing videos so on. The added layers are removed after the movement effect so that the environment becomes the same as the conventional environment. Accordingly, the user can use the effect according to the present invention while using the web environment without any inconvenience.

Therefore, it may be understood that the objective of the present invention is achieved. Although the present invention has been described based on embodiments, the present invention is not limited thereto and the scope of the present invention is defined by the appended claims.

What is claimed is:

1. A method of processing an effect of extracting and moving a section on an output display of a webpage, the method comprising the steps of:
(a) an extraction of section-position value step wherein position value of the section of a particular file on the output display of the webpage is extracted;
(b) a transparent layer generation step wherein a transparent layer having a size fitting the size of the output display of the webpage is generated;
(c) an entire output display capture layer generation step wherein the output display of the webpage is captured and the captured output display of the webpage is put on the transparent layer so that an entire output display capture layer having the captured output display of the webpage thereon is generated;
(d) a section capture layer generation step wherein a section layer having a size fitting the size of the section is generated according to the position value of the section extracted in the extraction of section-position value step and a section capture layer is generated by capturing a section at position corresponding to the position value of the section extracted in the extraction of section-position value step from the entire output display capture layer and putting the captured section on the section layer; and
(e) a moving effect production step producing an effect that the section capture layer is moved.
